(19) United States
(12) Patent Application Publication
(10) Pub. No.: US 2024/0143924 A1
(43) Pub. Date: May 2, 2024

(54) SYSTEM AND A METHOD FOR STOCHASTICALLY IDENTIFYING AN ENTITY IN AN INPUT DATA

(71) Applicant: Innoplexus AG, Eschborn (DE)

(72) Inventor: Oliver Pfante, Hardenbergstr. (DE)

(73) Assignee: Innoplexus AG, Eschborn (DE)

(21) Appl. No.: 17/977,446

(22) Filed: Oct. 31, 2022

(51) Int. Cl. G06F 40/295; G06F 40/205; G06F 40/247; G06F 40/40

(52) U.S. Cl. CPC G06F 40/295; G06F 40/205; G06F 40/247; G06F 40/40

(57) ABSTRACT

The present disclosure describes a system and method for identifying an entity in an input data. The present disclosure seeks to provide a solution to the existing problem of accessing entire components of input strings together. Moreover, the present disclosure provides an optimal way of substantially reducing effort required in accessing an entity. Furthermore, the present disclosure seeks to overcome the problem of text segmentation, i.e., the requirement of exact words in an input string for identifying the correct entity in an input string. Beneficially, the disclosed system and method utilizes any name normalization algorithm to allow for fuzzy keyword matching that can be used as a named entity recognition in an input data. The present disclosure provides an effortless and less time-consuming solution for identifying correct entity in an input data.

### FIELD OF INVENTION

The present disclosure relates generally to data processing; and more specifically, to stochastic keyword processing. In general, the present disclosure is related to a system and method for identifying an entity in an input data. Moreover, the present disclosure also relates to computer readable medium containing program instructions for execution on a computer system, which when executed by a computer, cause the computer to perform method steps for identifying an entity in an input data.

### BACKGROUND

With the rapid accumulation of online articles, developing accurate and efficient text-mining techniques for extracting knowledge from articles has become important. In the text-mining, named entity recognition (NER) is an important element. Named entities are meaningful real-world objects in predefined specific domains, and they are presented as single words or multi-word phrases in texts. NER involves identifying both predefined entities as well as the domain of the entities or the entity types from informal texts. After single words or multiword phrases in texts have been recognized, the next step is named entity normalization by assigning suitable identifiers to recognized entities. For general entities, several natural language processing (NLP) studies, such as assigning entities to relevant Wikipedia® abstracts or corresponding nodes in knowledge base, have been performed. Specifically, in biomedical articles, named entity normalization is challenging because many biological terms have multiple synonyms and term variations, and they are often referred to using abbreviations. To resolve these ambiguities, several NER and normalization studies have been conducted for several entity types such as biological entities (genes, proteins, diseases, and disorders) and chemical entities (drugs and compounds).

Interestingly, there is a technique of fuzzy string matching that is useful for finding strings that match a pattern approximately, rather than exactly. The fuzzy keyword search has an important role that enhances system usability by returning the matching files when users' searching input exactly match the predefined keywords or closest possible matching files based on keyword similarity semantics, when exact match fails. In other words, fuzzy string matching is a type of search that will find matches even when users misspell words or enter only partial words for the search. For example, as we see in Google® search engines. The algorithm behind fuzzy string matching does not simply look at the equivalency of two strings but rather quantifies how close two strings are to one another. This is usually done using a distance metric known as ‘edit distance’. There are different types of edit distances that are used like Levenshtein distance, Hamming distance, Jaro distance, etc. For example, the Levenshtein distance is an attempt to relax the condition of an exact match by a match up to a certain number of character mismatches. However, Levenshtein distance between two strings tends to get larger if the strings get longer. Therefore, entities with long surface forms like “non small cell lung cancer” are less likely to match with a term of some pre-defined set of synonyms. Furthermore, even Levenshtein distance cannot capture permutation of terms in compound strings like “stomach carcinoma” vs. “carcinoma stomach”.

On the other hand, the name normalization solutions are developed, based on techniques involving deep learning to mitigate the above issues. However, the major bottlenecks in processing texts, like patient files or publications, are slight variations in the surface strings i.e., their synonyms of the entities in these texts. E.g., a keyword processor which looks only for exact string matches of “prostate cancer” would miss the mention of “cancer of the prostate” in the sample patient record: the “patient suffered from cancer of the prostate in the past”. Hence, for such limitations instead of exact string matches, again one aims for fuzzy string matching and there has been considerable research efforts to overcome the limitations of exact string matches, especially in biomedical entity name normalization. Conventionally, the name normalization algorithms are designed to mitigate these issues and still enable the correct match of the surface string “cancer of the prostate” with the correct biomedical entity. However, the name normalization algorithms are not designed to cope with inputs which are not related to the entity. For example, the biomedical entities have several different surface forms. The name normalization algorithms expect surface forms of entities as inputs to normalize them. Therefore, the name normalization algorithms already need the output of a named entity recognition NER and cannot be utilized as such.

Therefore, with the problem that such name normalization algorithms expect a surface string as input to map it onto the entity which it represents, they cannot be utilized in text mining contexts where these surface strings must be recognized in the first place, like in NER. Currently, the named entity recognition (NER) and name normalization systems are either used in a serial pipeline or are learned jointly. Therefore, there are two separate regimes employed. On one side, keyword processors which work via plain string matches only. On the other hand, there is powerful name normalization techniques which require surface strings of entities as an input and cannot be used to find them in a text in the first place. Thus, the problem encountered is the challenge in searching of exact entity by a string and in the extraction of appropriate sub-string that represents an entity. Moreover, there lacks a mechanism to convert any entity linker like name normalization algorithm to turn into a named entity recognizer.

Therefore, in light of the foregoing discussion, there exists a need to overcome the aforementioned drawbacks for utilizing any name normalization algorithm to allow for fuzzy matches that can be used to develop efficient named entity recognition.

### SUMMARY

The present disclosure seeks to provide a system for identifying an entity in an input data. The present disclosure also seeks to provide a method for identifying an entity in an input data. The present disclosure also seeks to provide a computer readable medium, containing program instructions for execution on a computer system, which when executed by a computer, cause the computer to perform method steps for identifying an entity in an input data.

Furthermore, the present disclosure seeks to provide a solution to the existing problem of accessing entire components of input strings together, as the input data may have many components to identify the correct entity. Moreover, the present disclosure provides an optimal way of substantially reducing effort required in accessing an entity. Advantageously, the present disclosure provides recognition of correct entity in an input string. Furthermore, the present disclosure seeks to overcome the problem of text segmentation, i.e., the requirement of exact words in an input string by any name normalization algorithm, for identifying the correct entity in an input string. Beneficially, the disclosed system and method utilizes any name normalization algorithm to allow for fuzzy keyword matching that can be used as a named entity recognition in an input data. An aim of the present disclosure is to provide a solution that overcomes at least partially the problems encountered in prior art and provides an efficient method and system identifying an entity in an input data.

In an aspect, embodiments of the present disclosure provide a system for identifying an entity in an input data, wherein the system comprises a processor communicably coupled to a memory, wherein the processor is configured to:
receive the input data in the form of an input string;
split the input string into a plurality of segments, wherein each segment represents a natural language word;
create a plurality of sub-strings up to a pre-defined length using the plurality of segments;
execute a name normalization algorithm to identify synonyms for each sub-string of the plurality of sub-strings and generate a confidence score for each of the sub-string of the plurality of sub-strings, based on the relevance of the identified synonyms;
generate a list of candidate sub-strings having the confidence score higher than a pre-defined threshold;
construct a directed acyclic graph using the candidate sub-strings;
calculate the longest path with predefined optimization in the directed acyclic graph to obtain an identified entity in the input data.

Optionally, wherein the natural language word is a complete word with boundary characters on both sides of the word.

Optionally, wherein the processor is configured to identify the pre-defined length of the sub-string using a training data.

Optionally, wherein the name normalization algorithm is at least one of: BIOSYN, TripleNet or BERT ranking.

Optionally, the processor is configured to identify the pre-defined threshold of confidence score using the training data.

Optionally, wherein edges in the directed acyclic graph are represented by the candidate sub-strings and nodes of the directed acyclic graph are represented by the start and end of each of the candidate sub-strings.

Optionally, wherein a weight matrix is calculated for each of the edges in the directed acyclic graph.

Optionally, wherein the longest path with predefined optimization comprises the longest path with fewest number of edges in the directed acyclic graph.

Optionally, wherein the longest path with predefined optimization comprises the longest path with fewest number of edges in the directed acyclic graph and highest confidence score among the candidate sub-strings.

In a second aspect, embodiments of the present disclosure provide a method for identifying an entity in an input data, the method comprising:
receiving the input data in the form of an input string;
splitting the input string into a plurality of segments, wherein each segment represents a natural language word;
creating a plurality of sub-strings up to a pre-defined length using the plurality of segments;
executing a name normalization algorithm to identify synonyms for each sub-string of the plurality of sub-strings and generating a confidence score for each of the sub-string of the plurality of sub-strings, based on the relevance of the identified synonyms;
generating a list of candidate sub-strings having the confidence score higher than a pre-defined threshold;
constructing a directed acyclic graph using the candidate sub-strings;
calculating the longest path with predefined optimization in the directed acyclic graph to obtain an identified entity in the input data.

Optionally, wherein the natural language word is a complete word with boundary characters on both sides of the word.

Optionally, wherein the method comprises identifying the pre-defined length of the sub-string using a training data.

Optionally, wherein the name normalization algorithm is at least one of: BIOSYN, TripleNet or BERT ranking.

Optionally, the method comprises identifying the pre-defined threshold of confidence score using the training data.

Optionally, wherein edges in the directed acyclic graph are represented by the candidate sub-strings and nodes of the directed acyclic graph are represented by the start and end of each of the candidate sub-strings.

Optionally, wherein a weight matrix is calculated for each of the edges in the directed acyclic graph.

Optionally, wherein the longest path with predefined optimization comprises the longest path with fewest number of edges in the directed acyclic graph.

Optionally, wherein the longest path with predefined optimization comprises the longest path with fewest number of edges in the directed acyclic graph and highest confidence score among the candidate sub-strings.

In a third aspect, embodiments of the present disclosure provide a non-transitory computer readable storage medium, containing program instructions for execution on a computer system, which when executed by a computer, cause the computer to perform method steps of a method for identifying an entity in an input data, the method comprising the steps of:
receiving the input data in the form of an input string;
splitting the input string into a plurality of segments, wherein each segment represents a natural language word;
creating a plurality of sub-strings up to a pre-defined length using the plurality of segments;
executing a name normalization algorithm to identify synonyms for each sub-string of the plurality of sub-strings and generating a confidence score for each of the sub-string of the plurality of sub-strings, based on the relevance of the identified synonyms;
generating a list of candidate sub-strings having the confidence score higher than a pre-defined threshold;
constructing a directed acyclic graph using the candidate sub-strings;
calculating the longest path with predefined optimization in the directed acyclic graph to obtain an identified an entity in the input data.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

A better understanding of the present invention may be obtained through the following examples which are set forth to illustrate but are not to be construed as limiting the present invention.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for identifying an entity in an input data, in accordance with an embodiment of the present disclosure;

FIG. 2 is a schematic illustration of a flow diagram of the method for identifying an entity in an input data, in accordance with an embodiment of the present disclosure; and

FIG. 3 is exemplary schematic illustration of a flow diagram of the method for identifying biomedical entity in an input data, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item to which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

In an aspect, embodiments of the present disclosure provide a system for identifying an entity in an input data, wherein the system comprises a processor communicably coupled to a memory, wherein the processor is configured to:
receive the input data in the form of an input string;
split the input string into a plurality of segments, wherein each segment represents a natural language word;
create a plurality of sub-strings up to a pre-defined length using the plurality of segments;
execute a name normalization algorithm to identify synonyms for each sub-string of the plurality of sub-strings and generate a confidence score for each of the sub-string of the plurality of sub-strings, based on the relevance of the identified synonyms;
generate a list of candidate sub-strings having the confidence score higher than a pre-defined threshold;
construct a directed acyclic graph using the candidate sub-strings;
calculate the longest path with predefined optimization in the directed acyclic graph to obtain an identified entity in the input data.

In a second aspect, embodiments of the present disclosure provide a method for identifying an entity in an input data, the method comprising:
receiving the input data in the form of an input string;
splitting the input string into a plurality of segments, wherein each segment represents a natural language word;
creating a plurality of sub-strings up to a pre-defined length using the plurality of segments;
executing a name normalization algorithm to identify synonyms for each sub-string of the plurality of sub-strings and generating a confidence score for each of the sub-string of the plurality of sub-strings, based on the relevance of the identified synonyms;
generating a list of candidate sub-strings having the confidence score higher than a pre-defined threshold;
constructing a directed acyclic graph using the candidate sub-strings;
calculating the longest path with predefined optimization in the directed acyclic graph to obtain an identified entity in the input data.

In a third aspect, embodiments of the present disclosure provide a non-transitory computer readable storage medium, containing program instructions for execution on a computer system, which when executed by a computer, cause the computer to perform method steps of a method for identifying an entity in an input data, the method comprising the steps of:
receiving the input data in the form of an input string;
splitting the input string into a plurality of segments, wherein each segment represents a natural language word;
creating a plurality of sub-strings up to a pre-defined length using the plurality of segments;
executing a name normalization algorithm to identify synonyms for each sub-string of the plurality of sub-strings and generating a confidence score for each of the sub-string of the plurality of sub-strings, based on the relevance of the identified synonyms;
generating a list of candidate sub-strings having the confidence score higher than a pre-defined threshold;
constructing a directed acyclic graph using the candidate sub-strings;
calculating the longest path with predefined optimization in the directed acyclic graph to obtain an identified entity in the input data.

The present disclosure provides the aforementioned system and method for identifying an entity in an input data. The described system identifies an entity in an input data. Thus, the system provides recognition of correct entity in an input data. The described system does not require users to exert manual effort in accessing entities associated with the user-input data. Consequently, the present disclosure provides an effortless and less time-consuming solution for identifying correct entity in an input data. Furthermore, the system provides a common platform for identifying correct entity associated with input string.

The disclosed system employs any name normalization algorithm and converts that into fuzzy keyword processing to obtain named entity recognition for the input data. The fuzzy keyword processing herein refers to stochastic keyword processing. The term “stochastic” in general refers to having a random probability distribution or pattern that may be analysed statistically. In an embodiment the named entity recognition is a biomedical named entity recognition. The system first receives an input data, in form of an input string. The system is further configured to split the input string into segments and create a plurality of sub-strings up to a pre-defined length using the segments. The system is then further configured to employ a name normalization algorithm to identify synonyms for each sub-string of the plurality of sub-strings and generate a confidence score for the synonym corresponding to each of the sub-string of the plurality of sub-strings. The processor is then configured to generate a list of candidate sub-strings having the confidence score higher than a pre-defined threshold. Beneficially, the processor is configured to construct a directed acyclic graph using the generated list of candidate sub-strings. Advantageously, the construction of the directed acyclic graph helps the system to calculate the longest path of the candidate sub-strings, wherein the longest path ensures to obtain maximum possible entities represented by the input data. More advantageously, the longest path of the candidate sub-strings is calculated with predefined optimization, wherein the predefined optimization comprises calculating the longest path with fewest number of edges in the directed acyclic graph and highest confidence score among the candidate sub-strings. The fewest edges ensures that the associated spans of candidate sub-strings are longest and that specific/accurate identification of entities are obtained. Beneficially, the predefined optimization calculating the highest confidence score among the candidate sub-strings helps in identification of entities when there are multiple candidate sub-strings with longest paths with fewest edges. Moreover, the highest confidence score ensures that a best choice among the candidate sub-strings is obtained for identification of an entity of the input data.

Throughout the present disclosure, the term “named entity recognition” refers to is an NLP-based technique to identify mentions of rigid designators from text belonging to particular semantic types. In general, NER refers to any subtask of information extraction that seeks to locate and classify named entities mentioned in unstructured text into pre-defined categories such as person names, organizations, locations, medical codes, time expressions, quantities, monetary values, percentages, etc. For example, in biomedical text mining, named entity recognition (NER) is an important task used to extract information from biomedical articles. Meaningful terms or phrases in a domain, which can be distinguished from similar objects, are called named entities, and named entity recognition (NER) is one of the important tasks for automatically identifying these named entities in text and classifying them into pre-defined entity types. NER is widely used across various fields and sectors to automate the information extraction process. For example, the medical named entities are prevalent in biomedical texts, and they play critical roles in boosting scientific discovery and facilitating information access. As a typical category of medical named entities, disease names are widely used in biomedical studies, including disease cause exploration, disease relationship analysis, clinical diagnosis, disease prevention, and treatment. Major research tasks in biomedical information extraction depend on accurate disease-named entity recognition (NER). Disease-named entity recognition (NER) is an important enabling technology to develop various downstream biomedical natural language processing applications. Most existing studies on NER mainly use machine learning methods with supervised, unsupervised, or semi-supervised training.

The system comprises a processor that is configured to first receive the input data in form of an input string. The input string may comprise at least one entity or no entity in the input data. In an exemplary embodiment, an input data is an article text. The text comprises various sentences that may relate to an entity. The processor is configured to extract such strings within the text as entities. For example, the text comprises input strings such as: “Glass is a non-crystalline”, “Naturally occurring obsidian glass was used by Stone Age societies”, “During the 13^{th} century, the island of Murano, Venice, became a centre for glass making”, “The most common and oldest applications of glass in optics are as lenses, windows, mirrors, and prisms”. The processor is then configured to perform segmentation process, wherein the input string is split into a plurality of segments. For example, in the input string “During the 13th century, the island of Murano, Venice, became a centre for glass making”, the plurality of segments are “13”, “century”, “island”, “Murano”, “Venice”, “centre”, “Glass making”. The processor is then configured to create a plurality of substrings based on a predefined length, using the plurality of segments. The plurality of substrings refers to set of spans of words in the input string. In an example, when the pre-defined length is up to 3, the sub-strings may comprise lengths equal to 3, 2 and 1. For the input sub-string stated in above example, the plurality of sub-strings created will be, for example, “13 century island”, “centre glass making”, “island Murano”, “Venice”, “glass”, etc. For each of the plurality of sub-strings, the processor is configured to execute a name normalization algorithm to identify synonyms and generate a confidence score to each of the sub-string of the plurality of sub-strings, based on the relevance of the identified synonyms. Further, a list of candidate sub-strings is generated from the plurality of sub-strings, having the confidence score higher than a pre-defined threshold. For example, a list of candidate sub-strings satisfying the criteria of pre-defined threshold, in the above input string, includes: “island Murano” “Venice” and “glass”. The processor is further configured to construct a directed acyclic graph (DAG) using the candidate sub-strings and calculate the longest path with predefined optimization in the directed acyclic graph to obtain an identified entity in the input data. Beneficially, the predefined optimization comprises the longest path with fewest number of edges in the directed acyclic graph and highest confidence score among the candidate sub-strings.

According to the invention as described herein the present disclosure, the system comprises a processor. Throughout the present disclosure, the term “processor” or “processing arrangement” as used herein relates to at least one programmable or computational entity configured to acquire process and/or respond to instructions for data curation. For example, the computational entity may include a memory, a network adapter and the likes. In another example, the processing arrangement includes, but are not limited to, a microprocessor, a microcontroller, a complex instruction set computing (CISC) microprocessor, a reduced instruction set (RISC) microprocessor, a very long instruction word (VLIW) microprocessor, or any other type of processing circuit for executing data management and curation instructions. Furthermore, the processing arrangement includes one or more individual processors, processing devices and various elements of a computer system associated with a processing device that may be shared by other processing devices. Additionally, one or more individual processors, processing devices, and elements are arranged in various architectures for responding to and processing the instructions that drive the system for curation of either curated and/or non-curated data.

Throughout the present disclosure, the term “memory” or “databases” or “database arrangement” as used herein, relates to an organized body of digital information regardless of a manner in which the data or the organized body thereof is represented. Optionally, the memory may be hardware, software, firmware and/or any combination thereof. For example, the organized body of digital information may be in a form of a table, a map, a grid, a packet, a datagram, a file, a document, a list or in any other form. The plurality of memory includes any data storage software and systems, such as, for example, a relational database like IBM DB2®, Google Cloud and Oracle 9®. Furthermore, the memory also includes a software program for creating and managing one or more memories. Optionally, the memory may be operable to support relational operations, regardless of whether it enforces strict adherence to a relational model, as understood by those of ordinary skill in the art. Additionally, the memory is populated by the elastic search libraries, elastic search databases, at least one relevant data element, topic-based web content and the likes. Optionally, the memory is populated by the operational data associated with the URIs, URLs and/or URNs and their related information.

According to the present disclosure, the processor is communicably coupled to a memory via the “communication interface” for accessing a computer network. Throughout the present disclosure, the term “communication interface” as used herein relates to an arrangement of interconnected components that are configured to facilitate data communication between one or more electronic devices, software modules and/or databases, whether available or known at the time of filing or as later developed. Furthermore, the communication interface facilitates data/content communication via a collection of interconnected (public and/or private) networks that are linked together by a set of standard protocols. Examples of standard protocols may include, but not limited to, Internet® Protocol (IP), Wireless Access Protocol (WAP), Frame Relay, Asynchronous Transfer Mode (ATM), Hypertext Transfer Protocol (HTTP), File Transfer Protocol (FTP), and the likes. Furthermore, any other suitable protocols using voice, video, data, or combinations thereof, can also be employed. The processing arrangement uses the communication interface to access the computer network that will be described later.

Throughout the present disclosure, the term “computer network” as used herein relates to a structure and/or module including interconnected computing components storing user-viewable hypertext documents (commonly referred to as Web documents or Web pages). Furthermore, the interconnected computing components form a distributed computing environment storing a distributed collection of interlinked, user-viewable hypertext documents accessible via the communication interface. Optionally, the wide area computer network can be implemented as client server architecture including client and server software components which provide access to such documents using standardized protocols. For example, standard protocol for locating and acquiring Web documents may be Hypertext Transfer Protocol (HTTP) and the Web pages are encoded using Hypertext Mark-up Language (HTML). Optionally, the wide area computer network refers to a global network of computers encompassing future mark-up languages and transport protocols that can be used in place of (or in addition to) Hypertext Mark-up Language (HTML) and Hypertext Transfer Protocol (HTTP) for communication.

In an embodiment, for identifying biomedical entity in an input data, the processor is first configured to receive the input data in the form of an input string. The input string comprises a plurality of segments, wherein each segment represents a natural language word. Herein, segments refer to multiple words. Moreover, each input string may or may not represent any entity.

Throughout the present disclosure, the term “entity” relates to categories, like but not limited to, names, people, cities, biomedical entities, chemical entities, entities in a specific domain, organizations, locations, quantities, monetary values, percentages, etc. Throughout the present disclosure, the term “biomedical entity” relates to therapeutic data unit related to biomedical sciences. In an example, the biomedical entity is generally represented by a predefined class like drug, disease, disorders, genes, proteins, etc. Throughout the present disclosure, the term “predefined class” refers to a specific group of entities having similar characteristics.

Throughout the present disclosure, the term “input data” as used herein, relates to data inserted by a user to the system. The input data refers to the data or information that is passed into the system via input devices. The input data is entered by the user using the input devices such as mobile, keyboard, mouse, tablet, microphone, etc. The user herein refers to a human or a bot. The types of input data can be an article, a publication of a research paper, a newsletter, search input, etc. Therefore, the input data may or may not contain references to any entities. The input data is in the form of an input string. Throughout the present disclosure, the term “input string” as used herein, refers to a data type used in programming, such as an integer and floating-point unit, but is used to represent text rather than numbers. It is comprised of a set of characters that can also contain spaces and numbers. Furthermore, the input string comprises a plurality of segments, for example, words with boundary characters such as punctuation mark, white space, etc on both sides of the word. Therefore, each segment of the plurality of segments represents a natural language word, wherein the natural language word is a complete word with boundary characters on both sides of the word. Throughout the present disclosure, the term “natural language word” as used herein, relates to words of a language that has developed and evolved naturally, through use by human beings, as opposed to an invented or constructed language, as a computer programming language.

Accordingly, in the above embodiment the processor is further configured to split the input string into a plurality of segments. The plurality of segments refer to list of words in the input strings. In an example, for input string “non small cell lung cancer”, the plurality of segments are “non”, “small”, “cell”, “lung”, “cancer”.

In the above embodiment the processor is further configured to create a plurality of sub-strings up to a pre-defined length using the plurality of segments. The pre-defined length L is also referred to as beam search horizon in natural language processing NLP. The plurality of sub-strings herein refers to span of words ignoring punctuation or special stand-alone characters. Throughout the present disclosure, the term “plurality of sub-strings” as used herein, refers to combination of one or more parts/words from the input string. For example, when a pre-defined length is set to be 4, then the plurality of sub-strings comprises strings with lengths up to 4 segments i.e., with lengths 1, 2, 3, and 4 segments. In an exemplary embodiment, the input string is w=w₁w₂ . . . wₖ and S=(s₁, . . . , s_{M}) denotes the plurality of sub-strings/set of all spans up to a pre-defined length L. For the pre-defined length L=4, in an example, the system calculates M=Σⱼ₌₀^{L-1} k−j. The start and end indices of a sub-string/span sᵢ in w are denoted by START(sᵢ) and END(sᵢ). Assuming an ordering of the spans based on START(sᵢ); spans with the same start index are ordered by END(sᵢ). In an example, the input string is a text string with word tokens like “Early Gravity, exclusion of foeta developmental disorder, exclusion of placental insufficiency”. The plurality of sub-strings, for example, are “Early Gravity”, “foeta developmental disorder”, “disorder, exclusion of placental insufficiency” etc. It is important to note, that some sub-strings of the input string might not denote any entity and might contain spelling error of words.

Optionally, the processor is configured to identify the pre-defined length of the sub-string using a training data.

Furthermore, the processor is configured to execute a name normalization algorithm to identify synonyms for each sub-string of the plurality of sub-strings and generate a confidence score for each of the sub-string of the plurality of sub-strings, based on the relevance of the identified synonyms. Notably, the name normalization algorithm is further used to filter the relevant sub-strings, that is, sub-strings which might represent entities.

Throughout the present disclosure, the term “name normalization algorithm” refers to any an algorithm employed to analyse any input data (articles, documents etc) to identify all aliases like entity classes, proper names, etc. and the entities those aliases belong to. In general, there are two main objectives of the normalization process: eliminate redundant data and ensure data dependencies make sense i.e., to ensure only related data is captured.

Throughout the present disclosure, the term “synonyms” refers to any word, morpheme, or phrase that means exactly or nearly the same as another word, morpheme, or phrase in a given language.

In an example, say Ω denotes an ontology, e.g., Mesh. Ω is a dictionary of unique IDs (DUI). Each DUI in the dictionary Ω has one or more synonyms. For example, N=[n₁, . . . , nₖ] denotes the union of all synonyms. Herein k denotes number of words/segments in the input string. Moreover, say f denotes a name normalization algorithm. f computes pairwise similarities f(x,nᵢ) between each synonym nᵢ in N and the input string x. The system then returns the synonym nᵢ which is the most similar one to the input x.

Throughout the present disclosure, the term “confidence score” refers to any a score calculated as an evaluation standard. The confidence score shows the probability of the synonym being identified correctly by the algorithm and is given as a percentage.

Throughout the present disclosure, the term “ontology” refers to a set of words associated as concepts, categories, and so forth of a given domain and/or a given subject. Typically, an ontology defines properties associated with the set of words and relations therebetween in the given domain. Moreover, the plurality of ontologies has knowledge pertaining to the utilization of the set of words based on properties of the words and relations between the words, in the given domain. In other words, the plurality of ontologies has semantic relations between the set of words relating to concepts, categories, and so forth in the given domain, wherein the semantic relations define at least one of: properties, relations, and utilization associated with the set of words. Optionally, each ontology of the plurality of ontologies relates to a specific domain such that each ontology has the set of words of the specific domain. In an example, a first ontology has a set of words of life science domain and is a disease ontology, a second ontology has a set of words of computer domain, a third ontology has a set of words of bio-technology domain, a fourth ontology has a set of words of medical science domain, a fifth ontology has a set of words of finance domain. Furthermore, a Disease Ontology (DO) is a formal ontology of human disease.

Optionally, the name normalization algorithm is at least one of: BIOSYN, TripleNet or BERT ranking. In the subsequent example, f generates from each input string a TfIdf-vector (Term frequency-Inverse document frequency) based on character level 3-grams and computes pairwise similarities between two TfIdf-vectors from their cosine-similarity. Optionally, the Tfidf-vectorizer is trained on an internal curated ontology D.

Subsequently, the system is configured to convert any name normalization algorithm f into a fuzzy keyword processor which correctly identifies in a text string span of words as a surface form of an entity in Ω which is not necessarily listed among the synonyms N because of a slight variation.

Throughout the present disclosure, the term “fuzzy keyword processor” or “fuzzy keyword matching” refers to a technique that helps identify two elements of text, strings, or entries that are approximately similar but are not the same. A fuzzy search searches for text that matches a term closely instead of exactly. Fuzzy searches helps in finding relevant results even when the search terms are misspelled. Moreover, the algorithm behind fuzzy string matching does not simply look at the equivalency of two strings but rather quantifies how close two strings are to one another. In the present disclosure, the fuzzy string-matcher is designed to only match entire/complete words (words with boundary characters on both sides) and to go first for the longest match, up to a certain pre-defined length. Calculating the longest match first ensures that the system first identifies as many entities as possible from the input string and the identification of the entity is more specific. In an example, the fuzzy keyword processor does not annotate “prostate” and “cancer” individually in the string “cancer, prostate” but goes for the entire string.

In an example, there is a text string w=w₁w . . . wₖ with k word tokens like “Early Gravity, exclusion of foeta developmental disorder, exclusion of placental insufficiency”. Some parts of w do not even denote any disease and the spelling error “foeta” makes entity recognition via an exact string match impossible. Hence, the system is configured to utilize a name normalization algorithm f as described above to allow for fuzzy matches with synonyms N of a disease ontology Ω which matches complete words only and matches longest strings first. The conversion of a name normalization algorithm f into a fuzzy keyword processor is described below.

In view of the above example, the system computes the most similar synonym f(sᵢ) for all sub-strings (spans in S) along with their confidence scores [x₁, . . . , x_{M}). The processor is further configured to generate a list of candidate sub-strings having the confidence score higher than a pre-defined threshold. The processor keeps only those substrings (spans in S) whose confidence scores xᵢ are greater than a certain threshold θ (θ=0.83 in an example). The selected spans are denoted by Y={y₁, . . . , y_{T}} with 0≤T≤M. If T=0, then there are no sub-strings to annotate. The set Y is called the candidate sub-strings of the input string w. Notably, it is assumed the same ordering of the candidate sub-strings is in Y as of the spans in S. In an example, Y derived from input string “Early Gravity, exclusion of foeta developmental disorder, exclusion of placental insufficiency” is presented in the below table 1.

TABLE 1

| START(sᵢ) | END(sᵢ) | Span sᵢ | Score xᵢ | Synonym f(sᵢ) |
|---|---|---|---|---|
| 3 | 5 | foeta developmental | 0.84 | poor foetal |
| | | | | development |
| 3 | 6 | foeta developmental | 0.88 | foetal |
| | | disorder | | neurodevelopmental |
| | | | | disorder |
| 4 | 5 | developmental | 0.94 | mental development |
| 4 | 6 | developmental | 1.00 | developmental |
| | | disorder | | disorder |
| 5 | 6 | disorder | 0.95 | tic disorder disorder |
| 5 | 9 | disorder exclusion | 0.86 | placental insufficiency |
| | | placental insufficiency | | disorder |
| 6 | 9 | exclusion placental | 0.83 | placental insufficiency |
| | | insufficiency | | |
| 7 | 9 | placental insufficiency | 1.00 | placental insufficiency |
| 8 | 9 | insufficiency | 0.91 | renal insufficiency |

Optionally, the processor is configured to identify the pre-defined threshold of confidence score using the training data.

Furthermore, the terms “pre-defined threshold θ” and the “pre-defined length L” are hyperparameters which can be fine-tuned on an already tagged text corpus or training data. Throughout the present disclosure, the term “training data” refers to a training dataset that is the initial data used to train machine learning models. In other words, training data is the tagged text, that is a text where the entities are already labelled. Training datasets are fed to machine learning algorithms to teach them how to make predictions or perform a desired task. E.g., if one wants to build a disease NER from a name normalization algorithm f one can take publicly available data sets like the BC5CDR Disease or NCBI Disease corpus where disease entities are already annotated in hundreds of articles.

The processor is further configured to construct a directed acyclic graph using the candidate sub-strings. The Edges in the directed acyclic graph are represented by the candidate sub-strings and nodes of the directed acyclic graph are represented by the start and end of each of the candidate sub-strings.

Throughout the present disclosure, the term “directed acyclic graph” refers to a conceptual representation of a series of activities. The order of the activities is depicted by a graph, which is visually presented as a set of circles, each one representing an activity, some of which are connected by lines, which represent the flow from one activity to another. Each circle is known as a “vertex” and each line is known as an “edge”. “Directed” means that each edge has a defined direction, so each edge necessarily represents a single directional flow from one vertex to another. “Acyclic” means that there are no loops (i.e., “cycles”) in the graph, so that for any given vertex, if you follow an edge that connects that vertex to another, there is no path in the graph to get back to that initial vertex. DAGs are useful for representing many different types of flows, including data processing flows. By thinking about large-scale processing flows in terms of DAGs, one can more clearly organize the various steps and the associated order for these jobs. In many data processing environments, a series of computations are run on the data to prepare it for one or more ultimate destinations. This type of data processing flow is often referred to as a data pipeline.

In view of the above example, the processor is configured to construct a directed acyclic graph G=(E,N). The nodes N′={0, . . . , M} are the start and end indices of the spans in S. The edges E=N′×N′ are the set of all 2-tuples of nodes. The nodes N′ are equal to k+1 values, wherein k represents the number of segments/words in the inputs string. Moreover, M herein represents the number of sub-strings of length up to the maximum length L.

Optionally, a weight matrix is calculated for each of the edges in the directed acyclic graph. Furthermore, the system is configured to define a weight matrix W=(wᵢⱼ)_{i,j=0, . . . , M} for the edges as follows:

$$\\ \begin{matrix}{w}_{ij} = \{ j - i \} if there is an s ∈ Y such that \\ START ( s ) = i and END ( s ) = j , 0 otherwise\end{matrix}$$

Notably, the weight matrix W=(wᵢⱼ)_{i,j=0, . . . , M} is a hyperparameter fine-tuned on an already tagged text corpus. The entries of W are either 0 or the length of a span which is a segment, that is, an element of Y. Optionally, other choices of the weights are reasonable as well and depend on the problem one wants to solve. E.g., instead of only taking the length j−i of a segment sᵢ into account, one could weight it by its score xᵢ getting wᵢⱼ=xᵢ*(j−i). Optionally, if there is already labelled data available, the entries of the matrix W themselves could be learned by assigning each synonym nᵢ its own weight and if f(sᵢ)=nᵢ then that weight is put into the position of W which is related to sᵢ.

Furthermore, the runtime of the algorithm is 0(k*L). Herein, k represents the number of words in the input string. Even though the system constructs the weight matrix W for all pairs it can prune edges among nodes with distances greater than L.

The processor is further configured to calculate the longest path with predefined optimization in the directed acyclic graph to obtain an identified entity in the input data. Optionally, the longest path with predefined optimization comprises the longest path with fewest number of edges in the directed acyclic graph. Optionally, the longest path with predefined optimization comprises the longest path with fewest number of edges in the directed acyclic graph and highest confidence score among the candidate sub-strings.

Advantageously, by construction of the DAG, the problem of a fuzzy string match on complete words only which goes for the longest match first is then translated into a graph problem: to find the longest path in G with the fewest number of edges. Notably, matching only complete words is guaranteed by the construction of the plurality of sub-strings (spans in S), that is, the edges of the graph G. Finding the longest path ensures the best possible recall of the fuzzy keyword processor subject to the confidence threshold θ which controls the keyword processor's precision: the higher the threshold the more similar is the fuzzy keyword processor with an ordinary one which looks for precise sub-string matches. Taking the shortest path among the longest ones picks the longest fuzzy matched sub-strings. E.g., the fuzzy matcher should not match the spans “foeta developmental” and “disorder” independently but the sub-string “foeta developmental disorder”. Since every longest path which contains the substring “foeta developmental” and “disorder” also contains the sub-string “foeta developmental disorder” choosing the longest path with the fewest number of edges prefers the longer match over the two shorter ones.

Optionally, for finding the longest path in a directed acyclic graph dynamic programming is employed. Throughout the present disclosure, the term “dynamic programming” as used herein, relates to an optimization technique over plain recursion. Wherever there is a recursive solution that has repeated calls for same inputs, it can be optimized by using Dynamic Programming. Using dynamic programming, the idea is to simply store the results of subproblems, so that there is no need to re-compute them when needed later. This simple optimization reduces time complexities from exponential to polynomial. For example, when writing simple recursive solution for Fibonacci Numbers, there are exponential time complexity involved and after optimizing it by storing solutions of subproblems, time complexity reduces to linear. Optionally, the longest path in a DAG can be calculated using brute force. Further, the system picks the paths with the fewest number of edges. Optionally, in case of multiple paths left, the system takes the one with the highest total score. In view of the above cited example, the system finds that two annotations are left, as shown in Table 2 below.

TABLE 2

| START(sᵢ) | END(sᵢ) | Span sᵢ | Score xᵢ | Synonym f(sᵢ) |
|---|---|---|---|---|
| 3 | 6 | foeta developmental | 0.88 | foetal |
| | | disorder | | neurodevelopmental |
| | | | | disorder |
| 6 | 9 | exclusion placental | 0.83 | placental |
| | | insufficiency | | insufficiency |

According to an embodiment, the present disclosure provides an interactive user interface for providing an input data to the system and to view the identified entity in the input data. Optionally, the user interface may show the constructed directed acyclic graph, all paths, all edges, longest path, shortest path, longest path with fewest edges and so forth. Throughout the present disclosure, the term “interactive user interface” relates to an arrangement that allows for interaction between the user and the system. The interactive user interface allows for obtaining inputs from the user and providing user-friendly, systematic, easily comprehensible, and customisable representations of information to the user. As a result, the interactive user interface facilitates the user in better organizing, viewing, analysis, and processing of information related to various fields. In another embodiment, the interactive user interface described herein can be easily implemented by way of the hardware system of the system.

The present disclosure also relates to the method as described above. Various embodiments and variants disclosed above apply mutatis mutandis to the method.

Optionally, wherein the natural language word is a complete word with boundary characters on both sides of the word.

Optionally, wherein the method comprises identifying the pre-defined length of the sub-string using a training data.

Optionally, wherein the name normalization algorithm is at least one of: BIOSYN, TripleNet or BERT ranking.

Optionally, the method comprises identifying the pre-defined threshold of confidence score using the training data.

Optionally, wherein edges in the directed acyclic graph are represented by the candidate sub-strings and nodes of the directed acyclic graph are represented by the start and end of each of the candidate sub-strings.

Optionally, wherein a weight matrix is calculated for each of the edges in the directed acyclic graph.

Optionally, wherein the longest path with predefined optimization comprises the longest path with fewest number of edges in the directed acyclic graph.

Optionally, wherein the longest path with predefined optimization comprises the longest path with fewest number of edges in the directed acyclic graph and highest confidence score among the candidate sub-strings.

The present disclosure also provides a non-transitory computer readable storage medium, containing program instructions for execution on a computer system, which when executed by a computer, cause the computer to perform method steps of a method for identifying an entity in an input data.

### DETAIL DESCRIPTION OF THE DRAWINGS

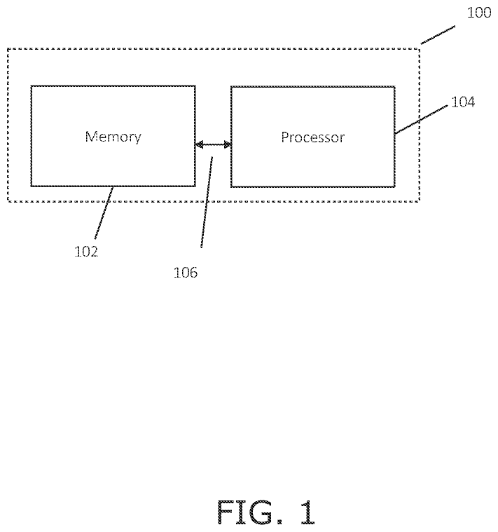

Referring to FIG. 1, there is shown a schematic illustration of a system 100 for identifying an entity in an input data, in accordance with an embodiment of the present disclosure. The system 100 comprises a memory 102 and a processor 104. The processor further comprises a communication interface 106 for accessing a computer network (not shown) and the memory 102.

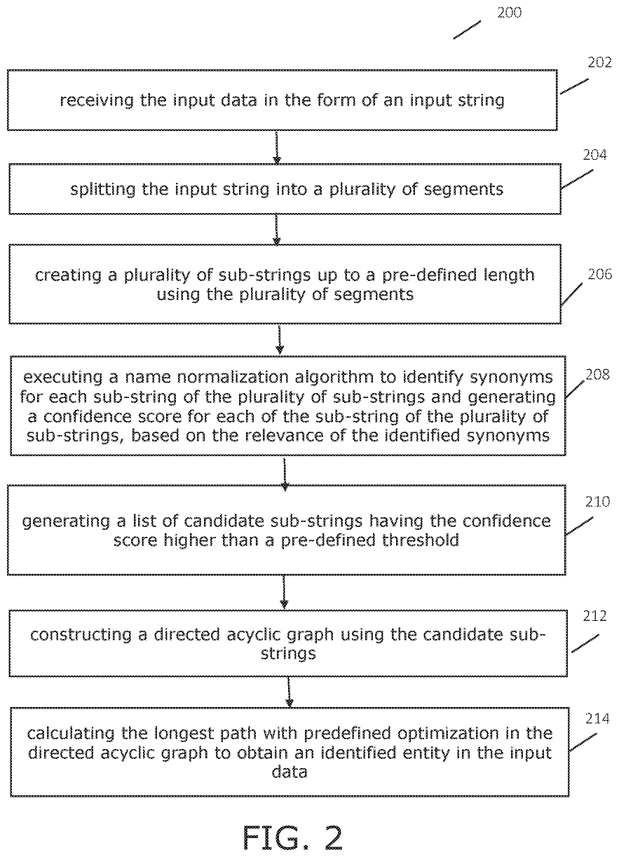

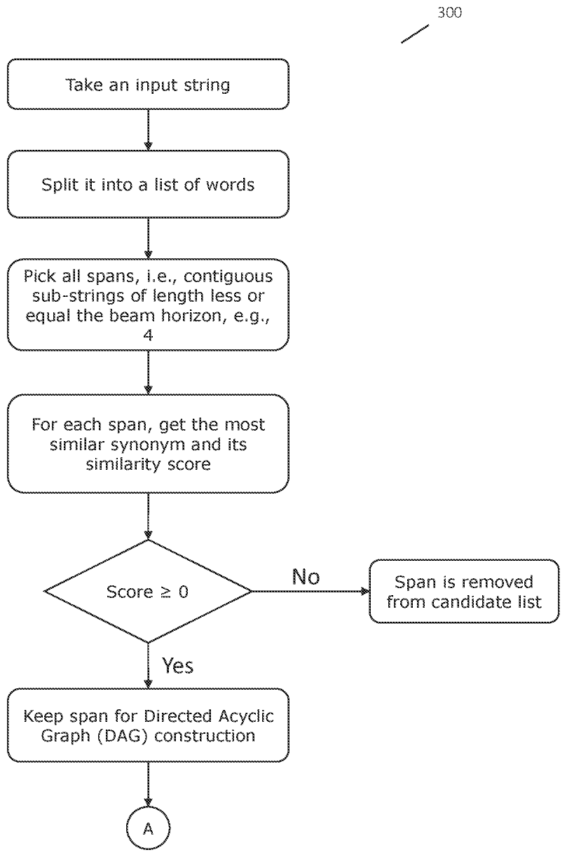

Referring to FIG. 2, there is shown a schematic illustration of a flow chart of a method for identifying an entity in an input data 200, in accordance with an embodiment of the present disclosure. At step 202 the method receives the input data in the form of an input string. At step 204 the method splits the input string into a plurality of segments. At step 206 the method creates a plurality of sub-strings up to a pre-defined length using the plurality of segments. At step 208 the method executes a name normalization algorithm to identify synonyms for each sub-string of the plurality of sub-strings and generate a confidence score for each of the sub-string of the plurality of sub-strings, based on the relevance of the identified synonyms. At step 210 the method generates a list of candidate sub-strings having the confidence score higher than a pre-defined threshold. At step 212 the method constructs a directed acyclic graph using the candidate sub-strings. At step 214 the method calculates the longest path with predefined optimization in the directed acyclic graph to obtain an identified entity in the input data.

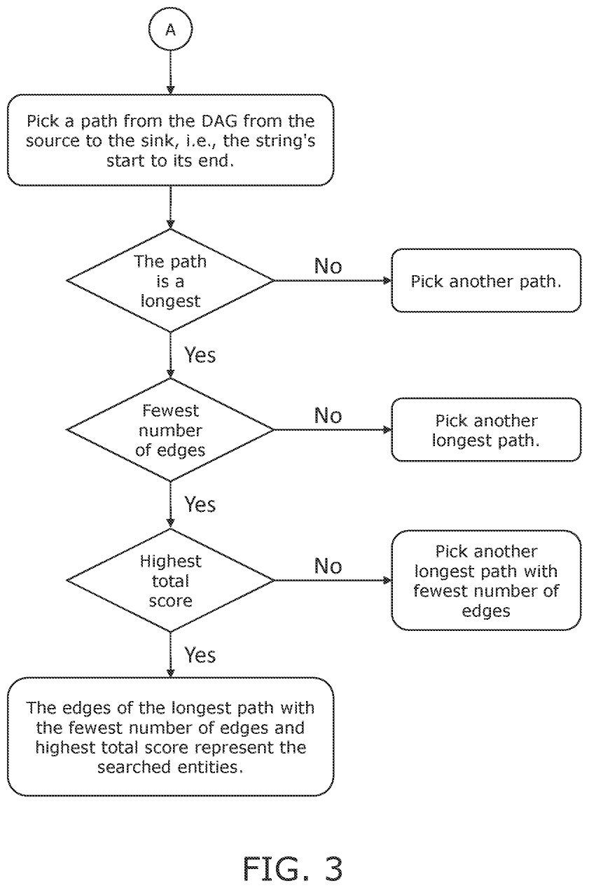

Referring to FIG. 3, there is shown an exemplary schematic illustration 300 of a flow chart of a method for identifying biomedical entity in an input data 200, in accordance with an embodiment of the present disclosure. According to this exemplary example, the method first receives an input string. For example, the input string is: “Early Gravity, exclusion of foeta developmental disorder, exclusion of placental insufficiency”. In the next step, the input string is split into a list of words i.e., a plurality of segments: Early, Gravity, exclusion, of, foeta, developmental disorder, exclusion, of, placental, insufficiency. Further, the method creates a plurality of sub-strings (all spans) up to a pre-defined length L=4. For example, a sub-string created with L=3 may be “foeta developmental disorder”. Further in the next step, the method gets the most similar synonym for the each of the plurality of sub-strings and their similarity score (confidence score). For example, for the sub-string “foeta developmental disorder” the most similar synonym found by the method is “foetal neurodevelopmental disorder” with a confidence score 0.88. In this particular example say the pre-defined threshold is 0.83. Therefore, the method keeps on generating a list of candidate sub-strings having the confidence score higher than the pre-defined threshold. In this example the sub-string “foeta developmental disorder” is a candidate sub-string. Accordingly, in cases when the confidence score of sub-strings is higher than the pre-defined threshold the method jumps to the next step of constructing a directed acyclic graph (DAG) wherein the spans/candidate sub-strings become edges and their start and end indices become nodes. For sub-strings whose confidence score is less than the pre-defined threshold, that sub-string is removed from the candidate list (list of candidate sub-strings). After the construction of DAG for selected candidate sub-strings the method picks a path from the DAG from the source to the sink, i.e., the string's start to its end. If the path is longest, the method moves to the next step otherwise the method picks another path. In the next step, the method checks if the longest path has the fewest edges. If Yes, then the method moves to the next step, otherwise the method picks another longest path with fewest number of edges. For identified longest paths with fewest edges, the method calculates highest total score (total sum). The method represents the edges of the longest path with the fewest number of edges and highest total score as the searched entities.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural where appropriate.

1. A system for identifying an entity in an input data, wherein the system comprises a processor communicably coupled to a memory, wherein the processor is configured to:
receive the input data in the form of an input string;
split the input string into a plurality of segments, wherein each segment represents a natural language word;
create a plurality of sub-strings up to a pre-defined length using the plurality of segments;
execute a name normalization algorithm to identify synonyms for each sub-string of the plurality of sub-strings and generate a confidence score for each of the sub-string of the plurality of sub-strings, based on the relevance of the identified synonyms;
generate a list of candidate sub-strings having the confidence score higher than a pre-defined threshold;
construct a directed acyclic graph using the candidate sub-strings;
calculate the longest path with predefined optimization in the directed acyclic graph to obtain an identified entity in the input data.

2. The system of claim 1, wherein the natural language word is a complete word with boundary characters on both sides of the word.

3. The system of claim 1, wherein the processor is configured to identify the pre-defined length of the sub-string using a training data.

4. The system of claim 1, wherein the name normalization algorithm is at least one of: BIOSYN, TripleNet or BERT ranking.

5. The system of claim 1, the processor is configured to identify the pre-defined threshold of confidence score using the training data.

6. The system of claim 1, wherein edges in the directed acyclic graph are represented by the candidate sub-strings and nodes of the directed acyclic graph are represented by the start and end of each of the candidate sub-strings.

7. The system of claim 6, wherein a weight matrix is calculated for each of the edges in the directed acyclic graph.

8. The system of claim 1, wherein the longest path with predefined optimization comprises the longest path with fewest number of edges in the directed acyclic graph.

9. The system of claim 8, wherein the longest path with predefined optimization comprises the longest path with fewest number of edges in the directed acyclic graph and highest confidence score among the candidate sub-strings.

10. A method for identifying an entity in an input data, the method comprising:
receiving the input data in the form of an input string;
splitting the input string into a plurality of segments, wherein each segment represents a natural language word;
creating a plurality of sub-strings up to a pre-defined length using the plurality of segments;
executing a name normalization algorithm to identify synonyms for each sub-string of the plurality of sub-strings and generating a confidence score for each of the sub-string of the plurality of sub-strings, based on the relevance of the identified synonyms;
generating a list of candidate sub-strings having the confidence score higher than a pre-defined threshold;
constructing a directed acyclic graph using the candidate sub-strings;
calculating the longest path with predefined optimization in the directed acyclic graph to obtain an identified entity in the input data.

11. The method of claim 10, wherein the natural language word is a complete word with boundary characters on both sides of the word.

12. The method of claim 10, wherein the method comprises identifying the pre-defined length of the sub-string using a training data.

13. The method of claim 10, wherein the name normalization algorithm is at least one of: BIOSYN, TripleNet or BERT ranking.

14. The method of claim 10, the method comprises identifying the pre-defined threshold of confidence score using the training data.

15. The method of claim 10, wherein edges in the directed acyclic graph are represented by the candidate sub-strings and nodes of the directed acyclic graph are represented by the start and end of each of the candidate sub-strings.

16. The method of claim 10, wherein a weight matrix is calculated for each of the edges in the directed acyclic graph.

17. The method of claim 10, wherein the longest path with predefined optimization comprises the longest path with fewest number of edges in the directed acyclic graph.

18. The method of claim 10, wherein the longest path with predefined optimization comprises the longest path with fewest number of edges in the directed acyclic graph and highest confidence score among the candidate sub-strings.

19. A non-transitory computer readable storage medium, containing program instructions for execution on a computer system, which when executed by a computer, cause the computer to perform method steps of the method for identifying an entity in an input data of claim 10.
